(19) United States
(12) Patent Application Publication
(10) Pub. No.: US 2016/0166450 A1
(43) Pub. Date: Jun. 16, 2016

(54) Clip-on Rotatable Folding Drink Holder

(71) Applicant: Thomas Graffy, Oxnard, CA (US)

(72) Inventor: Thomas Graffy, Oxnard, CA (US)

(21) Appl. No.: 14/963,879

(22) Filed: Dec. 9, 2015

Related U.S. Application Data
(60) Provisional application No. 62/090,222, filed on Dec. 10, 2014.

(51) Int. Cl. A61G 5/10; A47G 23/02

(52) U.S. Cl. CPC A61G 5/10; A47G 23/0225

(57) ABSTRACT

A clip-on drink holder includes a rotatable spring clip allowing a disabled patient with use of only one hand to attach the holder to a wheelchair. Spring clip arms reach rearward and two curved hands fold back inside the spring clip forming a mouth for attachment to tubular members of the wheelchair. The spring clip is covered in a high coefficient material to reduce or prevent slipping, for example, EPDM material. The spring clip is attached to the drink holder by a machine screw, and a spring washer and Nylon washer reside between the head of the machine screw and the spring clip, another Nylon washer resides between the spring clip and the drink holder, and another Nylon washer resides under a Nylon insert lock nut holding the machine screw in place.

### CROSS-REFERENCE TO RELATED APPLICATIONS

The present application claims the priority of U.S. Provisional Patent Application Ser. No. 62/090,222 filed Dec. 10, 2014, which application is incorporated in its entirety herein by reference.

### BACKGROUND OF THE INVENTION

The present invention relates to drink holders and to a clip-on drink holder for use by wheel chair bound patients.

There is a general need for liquids, especially for patients undergoing treatment and rehabilitation. Such patients are often wheelchair bound, and it is not desirable to include a permanently mounted drink holder which may interfere with folding the wheelchair, or be in the way of other optional accessories. Thus, there is a need for a clip-on drink holder suitable for wheelchairs. One known clip-on drink holder requires two hands to adjust the clip to the wheelchair, and patients often are not able to adjust the clip. Therefore a need remains for a clip-on drink holder which does not require adjustment and can be attached with a single hand.

### BRIEF SUMMARY OF THE INVENTION

The present invention addresses the above and other needs by providing a clip-on drink holder having a base and ring to support a drink. The drink holder includes a rotatable spring clip allowing a disabled patient with use of only one hand to attach the drink holder to a wheelchair. The spring clip reaches outward and two curved hands fold back inside the spring clip forming a mouth for attachment to tubular members of the wheelchair. The spring clip is covered in a high coefficient material to prevent slipping, for example, EPDM material. The spring clip is attached to the drink holder by a machine screw, and a spring washer and Nylon washer reside between the head of the machine screw and the spring clip, another Nylon washer resides between the spring clip and the drink holder, and another Nylon washer resides under a Nylon insert lock nut holding the machine screw in place. The drink holder can be attached to horizontal, vertical, or angled tubular member of the wheelchair, and then be rotated so that the ring and base are parallel with the ground.

In accordance with one aspect of the invention, there is provided a drink holder allowing use by a disabled patient. The drink holder is attachable to a wheel chair by engaging a spring clip attached to the back of the drink holder to any tubular member of the wheelchair, and rotating the drink holder into position, thus allowing one handed attachment.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 shows a wheel chair with a clip-on drink holder attached according to the present invention.

FIG. 2 shows a rear perspective view of the clip-on drink holder according to the present invention.

FIG. 3 shows a front perspective view of the clip-on drink holder according to the present invention.

FIG. 4 shows an exploded rear perspective view of the clip-on drink holder according to the present invention.

FIG. 5 shows a top view of the spring clip according to the present invention.

FIG. 6A shows a side view of the clip-on drink holder according to the present invention with a base and ring positioned for use.

FIG. 6B shows a side view of the clip-on drink holder according to the present invention with the ring folded.

FIG. 6C shows a side view of the clip-on drink holder according to the present invention with the base and ring folded.

FIG. 7A shows the holder base held in a generally vertical position according to the present invention.

FIG. 7B shows the holder base held in a generally horizontal position according to the present invention.

FIG. 8A shows a side view of the clip-on drink holder according to the present invention attached to a vertical tubular member of the wheelchair.

FIG. 8B shows a side view of the clip-on drink holder according to the present invention attached to a horizontal tubular member of the wheelchair.

FIG. 8C shows a side view of the clip-on drink holder according to the present invention attached to a diagonal tubular member of the wheelchair.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement.

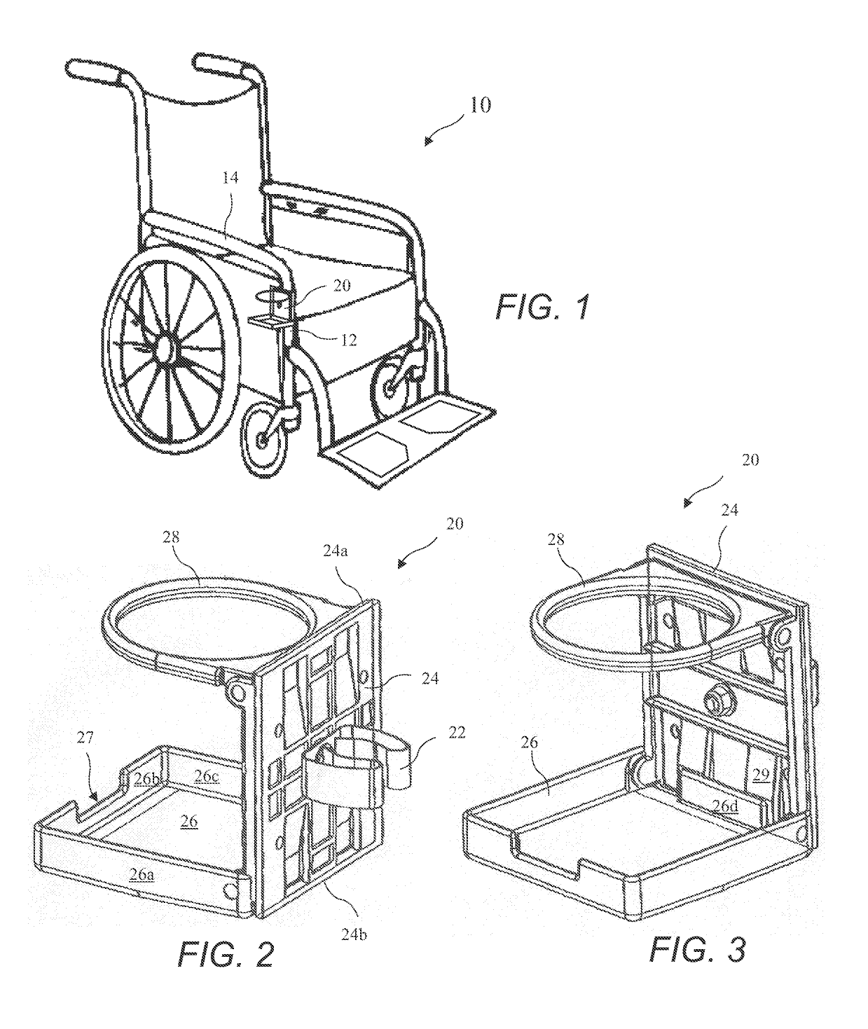

A wheel chair 10 with a clip-on drink holder 20 attached according to the present invention is shown in FIG. 1. The wheelchair includes vertical tubular members 12 and horizontal tubular members 14. The clip-on drink holder 20 may be easily attached to any short segment of a tubular member of the wheelchair 10.

A rear perspective view of the clip-on drink holder 20 is shown in FIG. 2 and a front perspective view of the clip-on drink holder 20 is shown in FIG. 3. The clip-on drink holder 20 included a generally vertical back 24, a ring 28 proximal to a back top 24a and a base 26 hingedly attached to the back 24 proximal to the base bottom 24b and foldable against the back 24. The base 26 extending generally horizontally forward from the back 24 and enclosed on the front and side by a right side 26a, a front 26b, and a left side 26c. The right side 26a, the front 26b, and the left side 26c about ½ inches high with a reduced height cutout 27 centered on the front 26b. The cutout 27 facilitating opening the drink holder 20. The ring 28 extending generally horizontally forward from the back 24.

A rear wall 26d reaches up from the base 26 proximal to the back 24. At least one leaf spring 29 resides behind the rear wall 26d. A spring clip 22 (also see FIG. 5) is attached to the back 24 reaching rearward from the rear of the clip-on drink holder 20.

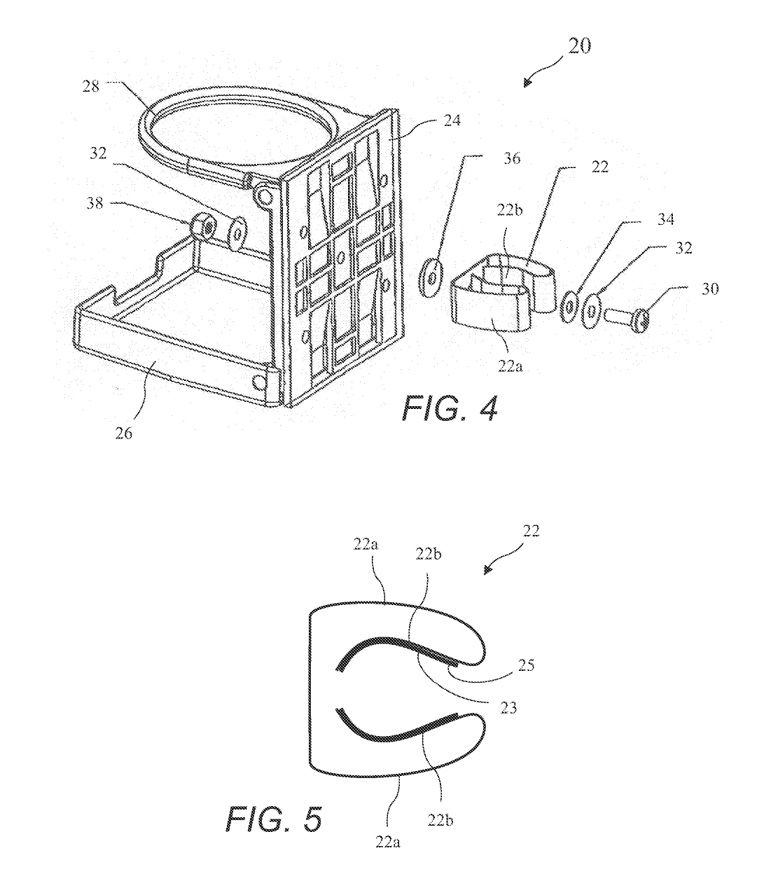

An exploded rear perspective view of the clip-on drink holder 20 is shown in FIG. 4. The spring clip 22 is attached to the drink holder 20 by a machine screw 30. A spring washer 32 and a first Nylon washer 34 reside between the head of the machine screw 30 and the spring clip 22. A second Nylon washer 36 resides between the spring clip 22 and the drink holder back 24, and another spring washer 32 resides under a Nylon insert lock nut 38 holding the machine screw 30 in place. The combination and order of the lock washer 38, the spring washers 32 and Nylon washers 34 and 36, provides a correct resistance to rotating the spring clip 22 to allow the drink holder 20 to be aligned vertically to hold a drink, and to hold the alignment.

A top view of the spring clip 22 is shown in FIG. 5. The spring clip 22 includes outward curved arms 22a reaching rearward and two curved hands 22b folding back inside the arms 22a forming a mouth for attachment to tubular members 12 and 14 of the wheelchair 10. The hands 22b include concave faces 23. A high friction material 25 covers each of the faces 23 of the hands 22b to reduce or prevent slipping, for example, an EPDM material.

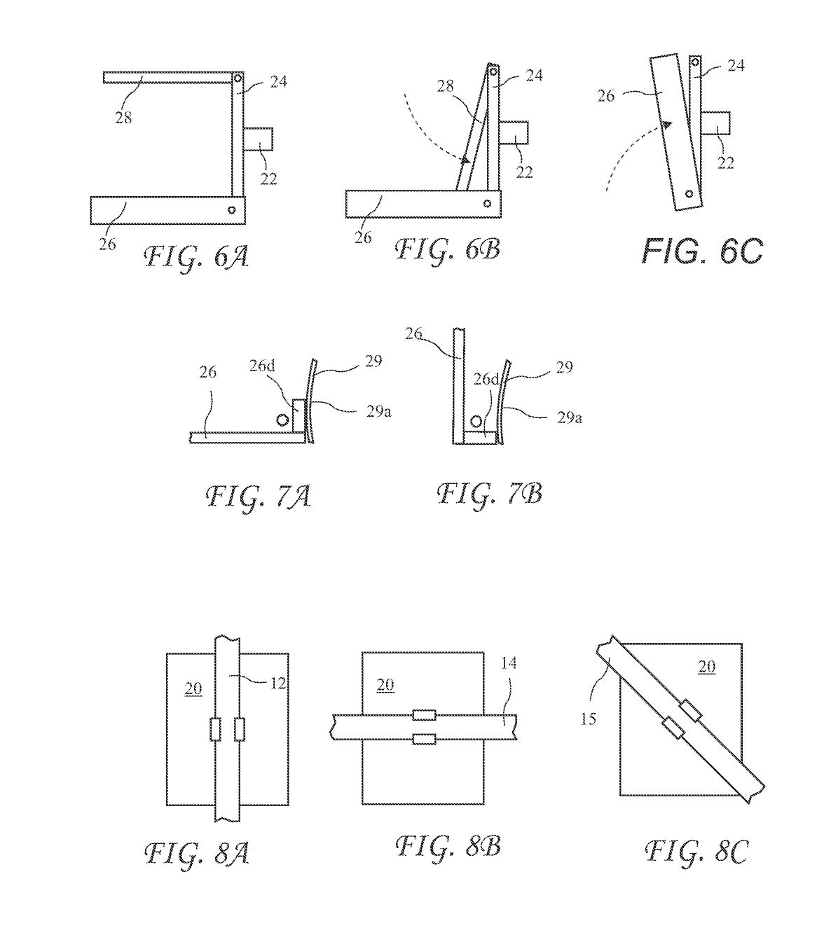

A side view of the clip-on drink holder 20 with a base 28 and ring 28 positioned for use is shown in FIG. 6A, a side view of the clip-on drink holder 20 with the ring 28 partially folded is shown in FIG. 6B, and a side view of the clip-on drink holder 20 with the base 26 partially folded and the ring 28 completely folded is shown in FIG. 6C.

The holder base 26 is shown held in a generally vertical position in FIG. 7A and the holder base 26 is shown in a generally horizontal position in FIG. 7B. In the generally horizontal position the rear wall 26d contacts the leaf spring 29 above a curve center 29a to urge the holder base 26 to remain in the open position. In the generally vertical position the rear wall 26d contacts the leaf spring 29 below the curve center 29a to urge the holder base 26 to remain in the closed position. While the leaf spring 29 is preferably a curved spring, it may also be a flat spring providing a similar urging.

A side view of the clip-on drink holder 20 attached to the vertical tubular member 12 of the wheelchair 10 is shown in FIG. 8A, a side view of the clip-on drink holder 20 attached to a horizontal tubular member 14 of the wheelchair 10 is shown in FIG. 8B, and a side view of the clip-on drink holder 20 attached to a diagonal tubular member 15 of the wheelchair 10 is shown in FIG. 8C.

While the invention herein disclosed has been described by means of specific embodiments and applications thereof, numerous modifications and variations could be made thereto by those skilled in the art without departing from the scope of the invention set forth in the claims.

I claim:

1. A clip-on drink holder comprising:
a generally vertical holder back having a back top and a back bottom;
a holder base extending generally horizontally forward from the holder back proximal to the back bottom, the holder base having generally vertical right and left side walls and a generally vertical front wall forming a base perimeter of the holder base;
a holder ring extending generally horizontally forward from the holder back proximal to the back top;
a spring clip attached to the holder back and extending rearward from the holder back, the spring clip comprising:
two arms reaching rearward; and
two curved hands fold back inside the arms forming a mouth for attachment to tubular members of a wheelchair.

2. The clip-on drink holder of claim 1, wherein facing surfaces of the curved hands are concave faces

3. The clip-on drink holder of claim 2, wherein facing surfaces of the curved hands are coated with a high friction material.

4. The clip-on drink holder of claim 3, wherein the high friction material is EPDM material.

5. The clip-on drink holder of claim 3, wherein the spring clip is attached to the hold back by a screw, and the spring clip is sandwiched between Nylon washers.

6. The clip-on drink holder of claim 5, wherein a spring washer resided under a head of the screw.

7. The clip-on drink holder of claim 6, wherein the screw is a machine screw and a Nylon insert locknut is threaded onto machine screw threads reaching through the holder back.

8. The clip-on drink holder of claim 7, wherein a second spring washer resides over the machine screw threads between the Nylon insert locknut and the holder back.

9. The clip-on drink holder of claim 1, wherein the holder base is hingedly attached to the holder back proximal to the back bottom to fold between the generally horizontal position and up to a generally vertical position against the holder back.

10. The clip-on drink holder of claim 9, wherein the holder ring is hingedly attached to the holder back proximal to the back top to fold between the generally horizontal position and down to a generally vertical position against the holder back, residing between the holder base and the holder back.

11. The clip-on drink holder of claim 1, wherein the base perimeter is generally square.

12. The clip-on drink holder of claim 11, wherein the holder ring defines a generally round opening.

14. The clip-on drink holder of claim 1, wherein:
a rear wall resides generally vertically at the rear of the holder base when the holder base is residing generally horizontally;
in the generally horizontal position of the holder base, the rear wall contacts a generally vertical leaf spring portion of the holder back to urge the holder base to remain in the open position; and
in the generally vertical position of the holder base, the rear wall contacts the leaf spring to urge the holder base to remain in the closed position.

15. The clip-on drink holder of claim 1, wherein:
the leaf spring is curved, a forward most portion of the leaf spring arching forward;
in the generally horizontal position of the holder base, the rear wall contacts the vertical leaf spring above the forward most portion of the leaf spring to urge the holder base to remain in the open position; and
in the generally vertical position of the holder base, the rear wall contacts the leaf spring below the forward most portion of the leaf spring to urge the holder base to remain in the closed position.

16. A clip-on drink holder comprising:
a generally vertical holder back having a back top and a back bottom;
a holder base extending forward from the holder back hingedly attached to the holder back proximal to the back bottom to fold between a generally horizontal position and up to a generally vertical position against the holder back, the holder base having right and left sides and a front forming a generally square perimeter of the holder base;
a holder ring defining a generally round opening and extending forward from the holder back hingedly attached to the holder back proximal to the back top to fold between a generally horizontal position and a down to generally vertical position against the holder back, residing between the holder base and the holder back;
a spring clip attached to the holder back and extending rearward from the holder back, the spring clip attached to the hold back by a screw and sandwiched between Nylon washers, a spring washer resided under a head of the screw, the spring clip comprising:
two arms reaching rearward; and
two curved hands fold back inside the arms forming a mouth for attachment to tubular members of a wheelchair, facing surfaces of the curved hands are concave faces coated with a high friction EPDM material.

17. A clip-on drink holder comprising:
a generally vertical holder back having a back top and a back bottom, the holder back including a curved leaf spring, a forward most portion of the leaf spring reaching forward;
a holder base extending forward from the holder back hingedly attached to the holder back proximal to the back bottom to fold between a generally horizontal position and up to a generally vertical position against the holder back, the holder base having right and left side walls and a front wall and a rear wall forming a generally square perimeter of the holder base;
in the generally horizontal position of the holder base, the rear wall contacts the vertical leaf spring above the forward most portion of the leaf spring to urge the holder base to remain in the open position;
in the generally vertical position of the holder base, the rear wall contacts the leaf spring below the forward most portion of the leaf spring to urge the holder base to remain in the closed position;
a holder ring defining a generally round opening and extending forward from the holder back hingedly attached to the holder back proximal to the back top to fold between a generally horizontal position and down to generally vertical position against the holder back, residing between the holder base and the holder back;
a spring clip attached to the holder back and extending rearward from the holder back, the spring clip attached to the hold back by a screw and sandwiched between Nylon washers, a spring washer resided under a head of the screw, the spring clip comprising:
two arms reaching rearward; and
two curved hands fold back inside the arms forming a mouth for attachment to tubular members of a wheelchair, facing surfaces of the curved hands are concave faces coated with a high friction EPDM material.
